(19) United States
(12) Patent Application Publication
(10) Pub. No.: US 2026/0196664 A1
(43) Pub. Date: Jul. 9, 2026

(54) COATED SEPARATOR FOR RECHARGEABLE BATTERY

(71) Applicant: Rivian IP Holdings, LLC, Irvine, CA (US)

(72) Inventors: Huaxin GONG, Fremont, CA (US); Judith Alvarado KIM, San Leandro, CA (US); Byoungchul YOU, Saratoga, CA (US); Cary Michael HAYNER, Half Moon Bay, CA (US); Soo KIM, Fremont, CA (US)

(21) Appl. No.: 19/319,533

(22) Filed: Sep. 4, 2025

Related U.S. Application Data
(60) Provisional application No. 63/741,598, filed on Jan. 3, 2025.

(51) Int. Cl. H01M 50/431; H01M 4/02; H01M 4/131; H01M 4/133; H01M 4/134; H01M 4/136; H01M 4/38; H01M 4/40; H01M 4/58; H01M 4/587; H01M 10/0525; H01M 10/0568; H01M 10/0569; H01M 50/249; H01M 50/414; H01M 50/451; H01M 50/457; H01M 50/491

(52) U.S. Cl. CPC H01M 50/431; H01M 4/131; H01M 4/133; H01M 4/134; H01M 4/136; H01M 4/386; H01M 4/405; H01M 4/5825; H01M 4/587; H01M 10/0568; H01M 10/0569; H01M 50/414; H01M 50/451; H01M 50/457; H01M 50/491; H01M 2004/027; H01M 2004/028; H01M 10/0525; H01M 50/249; H01M 2300/0034

(57) ABSTRACT

A separator for a rechargeable battery can include a porous polymer sheet having a first major surface and an opposing second major surface and, advantageously, a functional coating on one or both major surfaces. Such a coating can include a lithium ion generating compound such as a mixture of Li₃N and another metal nitride; or a lithium metal oxide; a lithium transition metal phosphate; or any mixture thereof. In addition, the porous polymer sheet can include a lithium metal coating or an alloy of lithium metal coating. Such separators are useful in rechargeable lithium ion battery cells.

### CROSS REFERENCE TO RELATED APPLICATIONS

This application claims the benefit of priority to U.S. Provisional Patent Application No. 63/741,598, entitled “COATED SEPARATOR FOR RECHARGEABLE BATTERY”, filed on Jan. 3, 2025, the disclosure of which is hereby incorporated herein in its entirety.

### INTRODUCTION

Batteries are often used as a source of power, including as a source of power for electric vehicles that include wheels that are driven by an electric motor that receives power from the battery.

Lithium ion batteries include separators between electrodes that are susceptible to mechanical damage and shrinkage at high temperature. To address some of these deficiencies, separators are coated with ceramics. However, such coatings increase the thickness and weight of the separator and correspondingly reduce the energy density and specific energy of a given cell employing such coated separators.

Aspects of the subject technology can help improve the reliability and/or energy density of batteries for use with electric vehicles, which can help to mitigate climate change by reducing greenhouse gas emissions.

### SUMMARY

The present description relates generally to a functionally coated separator for use in rechargeable battery cells. The coated separator includes a porous polymer sheet having a first major surface and an opposing second major surface and, advantageously, a first coating disposed on the first major surface of the porous polymer sheet that includes a lithium ion generating compound. In addition, the porous polymer sheet can optionally include a lithium metal or an alloy thereof coating disposed on the opposing second major surface. Advantageously, the coated separator of the present disclosure can be used in lithium ion battery cells and battery cells that include lithium metal or alloys thereof.

In some implementations, the lithium ion generating compound can include a lithium nitride, or mixtures of lithium nitrides and other metal nitrides; a lithium metal oxide; a lithium transition metal phosphate; or any mixture thereof.

In some aspects, the lithium ion generating compound can include a mixture of lithium nitrides and other nitrides such as Li₃N and MNₓ, wherein MNₓ is a metal nitride including a metal (M) selected from Na, K, Ca, Mg, Ba, V, Nb, Ti, Zr, Sr, or a mixture of any two or more thereof.

In other aspects, the lithium ion generating compound is a lithium metal oxide, a lithium transition metal phosphate, or a mixture thereof, wherein the metal of the lithium metal oxide comprises Ti, Mo, Mn, Co, Fe, Bi, W, Ni, or a mixture of any two or more thereof; and the transition metal of the lithium transition metal phosphate comprises V or Cr, or a mixture thereof.

In other implementations, the coated separator can optionally include a second coating disposed on the opposing second major surface of the porous polymer sheet. Such a coating can include lithium metal or an alloy thereof. Useful alloy coatings include a lithium alloy of LiₓM¹, wherein M¹ is Si, Sn, Ge, Al, or any combination thereof. In some aspects, the lithium metal or alloy thereof can be combined with another material, e.g., mixed with Li₂CO₃, Li₂O, LiF, Ti_{y}O_{z}, polypyrrole (PPy), graphene, or any combination thereof, to form the coating on the opposing major surface of the porous film.

In accordance with one or more other implementations, a battery cell includes the coated separator of the present disclosure. For example, the battery cell can include a coated separator with a first coating disposed on the first major surface of the porous polymer sheet and optionally a second coating disposed on the opposing second major surface of the porous polymer sheet in which the coating on the first major surface includes a lithium ion generating compound and the optional coating includes lithium metal or an alloy thereof. The battery cell can further include a cathode, an anode, and the coated separator between the cathode and anode. The cathode can include a lithium metal oxide, a lithium metal phosphate, lithium spinel, or a combination thereof. The anode can include a lithium metal, a lithium metal alloy, silicon, silicon oxide, tin alloys, a hybrid active material, graphite, or any combination thereof. The battery cell can further include an electrolyte, e.g., an electrolyte including a fluoride-containing compound, such as a fluoride-containing solvent or salt.

Other implementations of the present disclosure include a method of charging and discharging a battery cell that includes a coated separator of the present disclosure. Such a battery cell can be configured to have a cathode, an anode, and a coated separator of the present disclosure between the cathode and anode, and an electrolyte.

In one or more implementations, a battery cell having a coated separator as described herein can be included in a building and/or movable apparatus, e.g., a vehicle. For example, such a battery cell can be configured to power one or more components or systems of a building and/or a vehicle.

### BRIEF DESCRIPTION OF THE DRAWINGS

Certain features of the subject technology are set forth in the appended claims. However, for the purpose of explanation, several embodiments of the subject technology are set forth in the following figures.

FIG. 1A and FIG. 1B illustrate schematic perspective side views of example implementations of a vehicle having a battery pack in accordance with one or more implementations of the present disclosure.

FIG. 1C illustrates a schematic perspective view of a building having a battery pack in accordance with one or more implementations of the present disclosure.

FIG. 2A illustrates a schematic perspective view of a battery pack in accordance with one or more implementations of the present disclosure.

FIG. 2B illustrates a schematic perspective view of various battery modules that may be included in a battery pack in accordance with one or more implementations of the present disclosure.

FIG. 2C illustrates a cross-sectional end view of a battery cell in accordance with one or more implementations of the present disclosure.

FIG. 2D illustrates a cross-sectional perspective view of a cylindrical battery cell in accordance with one or more implementations of the present disclosure.

FIG. 2E illustrates a cross-sectional perspective view of a prismatic battery cell in accordance with one or more implementations of the present disclosure.

FIG. 2F illustrates a cross-sectional perspective view of a pouch battery cell in accordance with one or more implementations of the present disclosure.

FIG. 3 illustrates a coated separator in accordance with implementations of the present disclosure.

FIG. 4 illustrates another coated separate in which the coatings are patterned in accordance with implementations of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As discussed in further detail hereinafter, a battery cell including a coated separator of the present disclosure can be used to store and discharge electrical energy. A battery cell of the present disclosure can be used alone or multiple battery cells can be assembled or packaged together in the same housing, frame, or casing to form a battery subassembly, module and/or battery pack. Further, multiple battery subassemblies or modules can be assembled or packaged together to form a battery pack. The battery cells of a battery subassembly, module and/or pack can be electrically connected to generate a desired voltage output for the battery subassembly, module and/or pack. The battery subassembly, module and/or pack in turn can be electrically connected to a power-consuming component, such as a vehicle and/or an electrical system of a building.

### Vehicles, Battery Packs, Cells

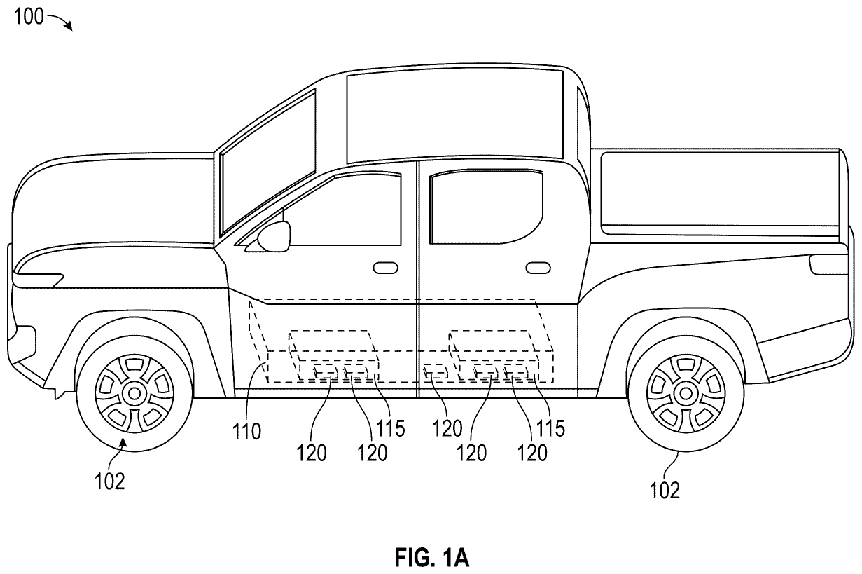

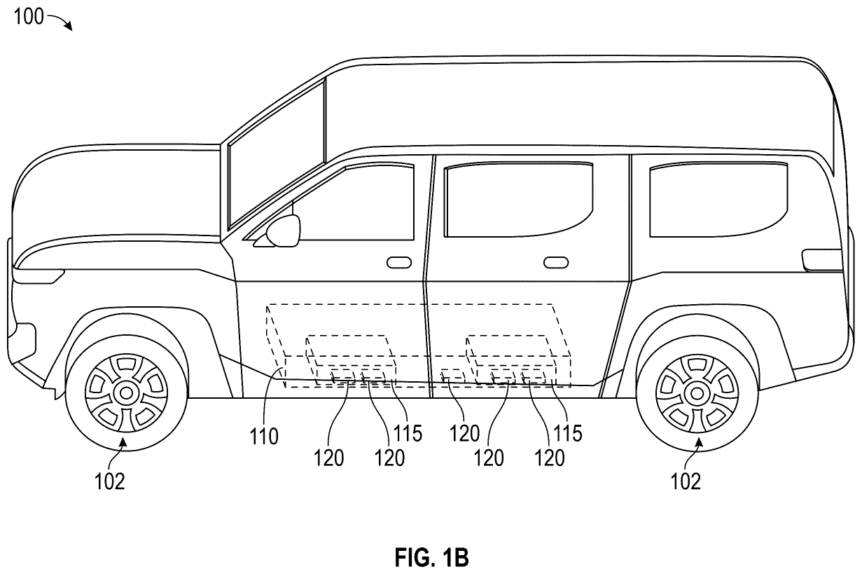

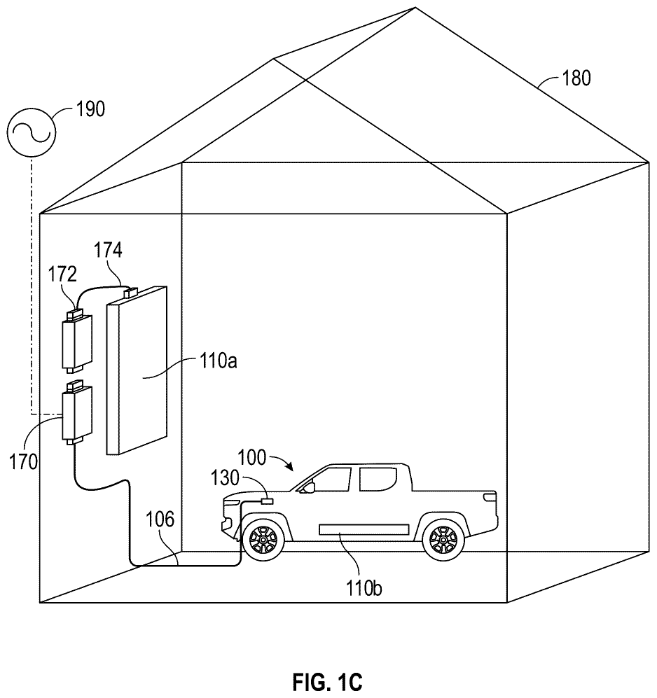

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each battery cell 120 can be included in a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. For example, the building 180 may be a residential building, a commercial building, or any other building. As shown, in one or more implementations, a battery pack 110 may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs, as non-limiting examples).

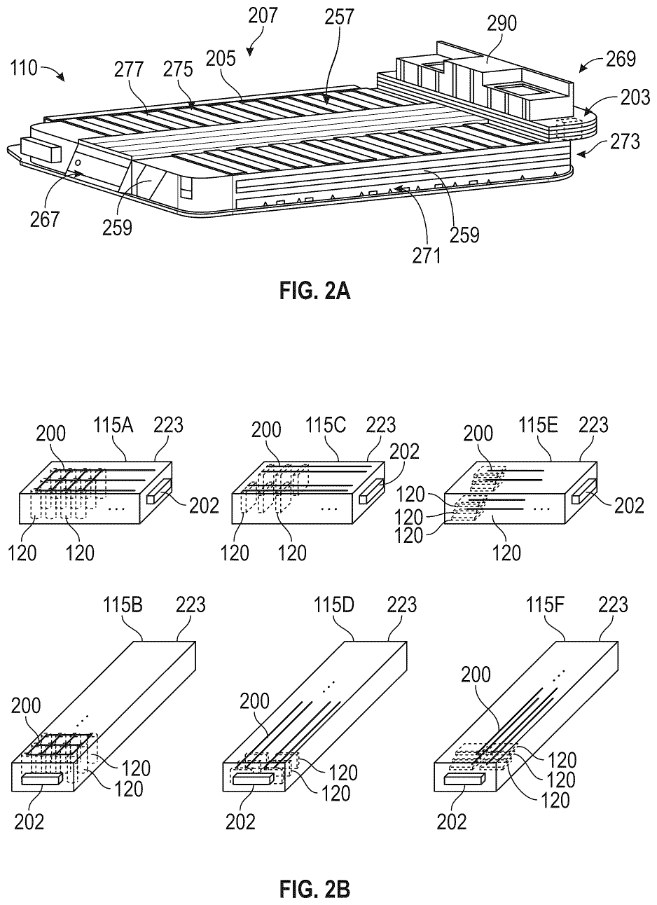

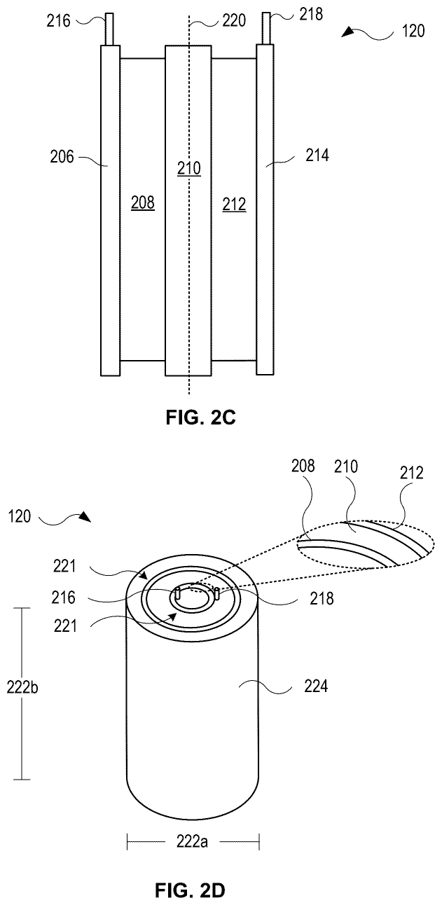

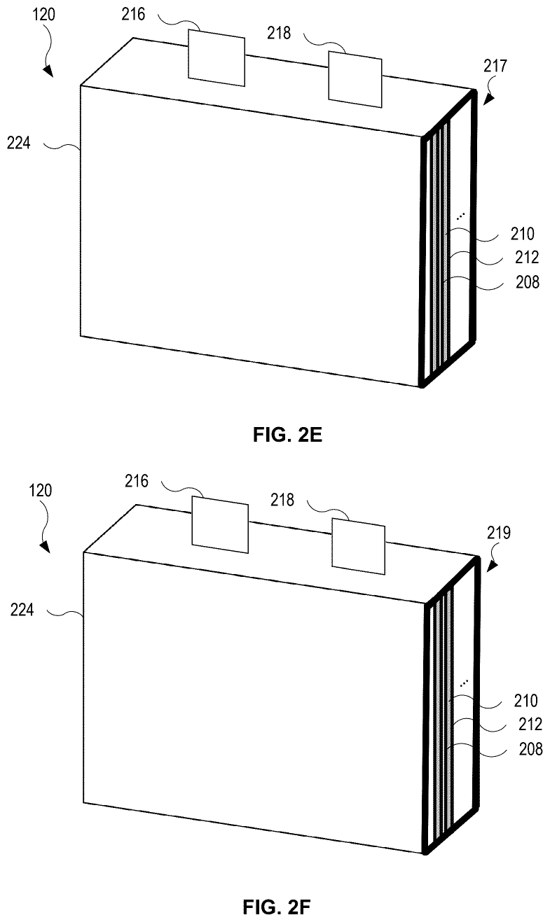

FIG. 2A depicts an example battery pack 110, in accordance with one or more implementations. As shown, the battery pack 110 may include an energy volume enclosure 205 (e.g., a battery pack housing, sometimes referred to herein as an enclosure). For example, the energy volume enclosure 205 may house or enclose an energy volume 207 for the battery pack 110, the energy volume 207 including one or more battery modules 115 and/or one or more battery cells 120, and/or other battery pack components. In one or more implementations, the energy volume enclosure 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

Battery pack 110 may include, within the energy volume 207 and the energy volume enclosure 205, multiple battery cells 120 (e.g., directly installed within the battery pack 110, or within batteries, battery units, battery subassemblies, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, battery subassemblies, and/or multiple battery modules 115 within the energy volume enclosure 205 to generate a desired output voltage for the battery pack 110.

As shown, the battery pack 110 may also include a modular electrical component assembly 290 (e.g., including a modular electronic component enclosure or a modular electrical component enclosure) mounted to the energy volume enclosure 205. In one or more implementations, the modular electrical component assembly 290 may include one or more of the conductive coupling elements for routing power from the battery cells 120 and/or battery modules 115 within the energy volume enclosure 205 (e.g., within the energy volume 207) to one or more external connection ports, such as an electrical contact 203 (e.g., a high voltage terminal, port, or connector). For example, an electrical cable or harness may be connected between the electrical contact 203 and an electrical system of the vehicle 100 or the building 180, to provide electrical power to the vehicle 100 or the building 180. The energy volume enclosure 205 may have a front end 267 and a rear end 269. In one or more implementations, when the battery pack 110 is installed in the vehicle 100, the battery pack 110 may be arranged with the front end 267 closer to the front end 131 of the vehicle and the rear end 269 closer to the rear end 133 of the vehicle. As shown, the modular electrical component assembly 290 may be mounted to the energy volume enclosure 205 (e.g., to a lid 277 of the energy volume enclosure 205) at or near the rear end 269 in one or more implementations.

In one or more implementations, the battery pack 110 may include one or more additional features, such as thermal control structures (e.g., cooling lines and/or plates and/or heating lines and/or plates). For example, thermal control structures may couple thermal control structures and/or fluids to the battery modules 115, battery units, batteries, and/or battery cells 120 within the energy volume enclosure 205, such as by distributing fluid through the battery pack 110.

For example, the thermal control structures may form a part of a thermal/temperature control or heat exchange system that includes one or more thermal components such as plates or bladders that are disposed in thermal contact with one or more battery modules 115 and/or battery cells 120 disposed within the energy volume enclosure 205. For example, a thermal component may be positioned in contact with one or more battery modules 115, battery units, batteries, and/or battery cells 120 within the energy volume enclosure 205. In one or more implementations, the battery pack 110 may include one or multiple thermal control structures and/or other thermal components for each of several top and bottom battery module pairs. As shown, the battery pack 110 may include an electrical contact 203 (e.g., a high voltage connector or port) by which an external load (e.g., the vehicle 100 or an electrical system of the building 180) may be electrically coupled to the battery modules and/or battery cells in the battery pack 110.

As shown, the energy volume enclosure 205 of the battery pack 110 may include a lid 277. For example, the lid 277 may cover and extend over one or more battery modules 115, battery cells 120, and/or other battery subassemblies within the energy volume enclosure 205. In the example of FIG. 2A, the lid 277 may be a deep-drawn structure that forms a top 257, and one or more sidewalls 259 (e.g., four sidewalls), of the energy volume enclosure 205. As discussed in further detail hereinafter, the energy volume enclosure 205 may also include a tray or other housing structure (e.g., at the bottom of the energy volume enclosure) that interfaces with the lid 277 to enclose one or more battery modules 115, battery cells 120, and/or other battery subassemblies within the energy volume enclosure 205 (e.g., within a space defined by the top 257 and the sidewalls 259 of the lid 277). For example, the energy volume enclosure 205 may include a tray panel that is removable to expose an opening in the bottom of the lid 277.

In the example of FIG. 2A, the lid 277 is provided with ribbing 275 (e.g., for additional strength). In the example of FIG. 2A, the battery pack 110 includes one or more mounting features 273 (e.g., for mounting the battery pack 110 to one or more body structures of a vehicle, such as the vehicle 100). As shown in FIG. 2A, and as discussed in further detail hereinafter, the energy volume enclosure 205 may include one or more sidewall structures 271. The sidewall structures 271 may be attached to, and/or extend long, a sidewall 259 of the lid 277, and may provide impact absorption and/or redistribution functions to distribute energy from a side impact to the battery pack 110 (e.g., from a side impact to a vehicle 100) away from and/or around the one or more battery modules 115, battery cells 120, and/or other battery subassemblies within the energy volume enclosure 205.

FIG. 2B depicts various examples of battery modules 115 that may be disposed in the battery pack 110 (e.g., within the energy volume enclosure 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or busbar 202. For example, the busbar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the energy volume enclosure 205. As shown, the battery module 115B may also include a busbar 202 electrically coupled to the interconnect structure 200. For example, the busbar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or busbar 202. For example, the busbar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the energy volume enclosure 205. As shown, the battery module 115D may also include a busbar 202 electrically coupled to the interconnect structure 200. For example, the busbar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or busbar 202. For example, the busbar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the energy volume enclosure 205. As shown, the battery module 115E may also include a busbar 202 electrically coupled to the interconnect structure 200. For example, the busbar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation). In one or more implementations, a battery pack 110 may be provided with three elongated battery modules (e.g., three of battery modules 115B, 115D, and/or 115F).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the energy volume enclosure 205) may include or define a plurality of structures for positioning of the battery cells 120 directly within the energy volume enclosure 205.

FIG. 2C illustrates a cross-sectional end view of a portion of a battery cell 120. As shown in FIG. 2C, a battery cell 120 may include an anode 208, an electrolyte 210, and a cathode 212. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214). In various implementations, the electrolyte 210 is a liquid electrolyte and the battery cell 120 includes a separator 220 that separates the anode 208 from the cathode 212. In one or more implementations separator 220 is a coated separator of the present disclosure.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. As shown, the battery cell 120 includes separator 220 that separates the anode 208 from the cathode 212. In an implementation in which the battery cell 120 is implemented as a lithium-ion battery cell, the electrolyte 210 may include a lithium salt in an organic solvent. In accordance with the present disclosure, separator 220 includes a porous base film formed from one or more insulating materials (e.g., a polymer such as polyethylene, polypropylene, polyolefin, and/or polyamide, or other insulating materials such as rubber, glass, cellulose or the like). Separator 220 further includes one or more functional coatings on either or both major surfaces thereof, e.g., it is a coated separator. Coated separator 220 may prevent contact between the anode 208 and the cathode 212, and may be permeable to the electrolyte 210 and/or ions within the electrolyte 210.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 224 having a cylindrical outer shape, which includes dimension 222a (e.g., cylinder diameter, battery cell diameter) and a dimension 222b (e.g., cylinder length). As shown in the enlarged view, the anode 208, a coated separator 220 of the present disclosure, and the cathode 212 may be rolled into one or more substantially cylindrical windings 221. As shown, one or more windings 221 of the anode 208, the separator 220, and the cathode 212 may be disposed within the cell housing 224. For example, a coated separator layer may be disposed between adjacent ones of the windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 224 having a right prismatic outer shape. As shown, one or more layers of the anode 208, the cathode 212, and the coated separator 220 disposed therebetween may be within the cell housing 224 having the right prismatic shape. As examples, multiple layer of the anode 208, coated separator 220, and cathode 212 can be stacked, or a single layer of the anode 208, separator 220, and cathode 212 can be formed into a flattened spiral shape and provided in the cell housing 224 having the right prismatic shape. In the implementation of FIG. 2E, the cell housing 224 has a relatively thick cross-sectional width 217 and is formed from a rigid material. For example, the cell housing 224 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 224 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the first terminal 216 and the second terminal 218 outside the cell housing 224 in order to contact an interconnect structure (e.g., interconnect structure 213 shown in of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the coated separator 220 disposed therebetween may be disposed within the cell housing 224 that forms a flexible or malleable pouch housing. In the implementation of FIG. 2F, the cell housing 224 has a relatively thin cross-sectional width 219. For example, the cell housing 224 in the implementation of FIG. 2F may be formed from a flexible or malleable material (e.g., a foil, such as a metal foil, or film, such as an aluminum-coated plastic film). For example, the cross-sectional width 219 of the cell housing 224 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may form on two different sides (e.g., opposing sides, such as a top side and a bottom side) of the battery cell 120. The first terminal 216 and the second terminal 218 may be formed on the same side or different sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes, e.g. semisolid electrolytes. One or more of the battery cells 120 may be included a battery module 115 or a battery pack 110, such as to provide an electrical power supply for components of the vehicle 100, the building 180, or any other electrically powered component or device. The cell housing 224 of the battery cell 120 can be disposed in the battery module 115, the battery pack 110, or installed in any of the vehicle 100, the building 180, or any other electrically powered component or device.

### Coated Separator

As discussed above, a battery cell (e.g., battery cell 120) including a coated separator of the present disclosure can be used to store and discharge electrical energy and implemented in a building and/or movable apparatus. The coated separator of the present disclosure advantageously includes a coating having functional material that can participate in the electrochemical operation of a lithium ion battery. Such a separator can include a base film, e.g., a porous polymer sheet having a first major surface and an opposing second major surface, and a first coating disposed on the first major surface of the base film including a lithium ion generating compound, for example. In addition, the base film can further include a second coating disposed on the opposing second major surface of the base film. Such a second coating can include a lithium metal or an alloy thereof.

While non-functional coatings on a battery separator can enhance the separator's physical properties to provide physical protection against battery degradation, especially at a high temperature, such non-functional coatings tend to increase the thickness and weight of the separator without participating in the electrochemical operation of the battery (i.e., an inactive component) and consequently reduce the energy density and specific energy of the battery cell. In contrast to a non-functional coating, the separators the present disclosure include a coating that can participate, at least initially, in the electrochemical operation of the battery, e.g., by including a lithium or lithium ion reservoir, to facilitate cell efficiency and improve cell energy during operation of the battery cell while also serving to protect the base film of the separator.

Aspects of the subject technology described herein relate to a lithium ion battery cell including a cathode, an anode, and a coated separator of the present disclosure between the cathode and anode. In some implementations, the coated separator includes a porous polymer sheet having a first coating disposed on a first major surface of the porous polymer sheet comprising a lithium ion generating compound facing the cathode and a second coating disposed on an opposing second major surface of the porous polymer sheet comprising lithium metal or an alloy thereof facing the anode.

In addition, a battery cell of the present disclosure can include a liquid electrolyte such as a salt dissolved in a solvent medium. A wide variety of solvent media can be included with a liquid electrolyte of the present disclosure such as carbonates, ethers and acetates, for example. In one aspect of the present disclosure, the electrolyte includes one or more carbonate solvents such as dimethyl carbonate (DMC), diethyl carbonate (DEC), and ethyl methyl carbonate (EMC), ethylene carbonate (EC), propylene carbonate (PC), vinylene carbonate (VC), fluoroethylene carbonate (FEC), vinyl ethylene carbonate (VEC), etc. or mixtures thereof; and/or one or more acetate solvents such as ethyl acetate (EA), methyl acetate (MA), etc. or mixtures thereof. For lithium ion battery cells, a variety of lithium salts may be added to the electrolyte such as lithium hexafluorophosphate (LiPF₆) lithium tetrafluoroborate (LiBF₄), lithium perchlorate (LiClO₄), lithium hexafluoroarsenate (LiAsF₆), lithium triflate (LiSO₃CF₃), lithium bis(fluorosulfonyl)imide (LiFSI), lithium bis(trifluoromethanesulfonyl)imide (LiTFSI), etc., or a mixture thereof. In some aspects, a battery cell of the present disclosure includes a liquid electrolyte including a fluoride-containing compound, e.g., a fluorine containing solvent of salt.

As an alternative to a liquid electrolyte, a battery cell of the present disclosure can include a semisolid electrolyte such as a salt dissolved in a solvent medium. Such semisolid electrolytes have properties between those of a liquid and a solid and can include solid particles (like ceramic or polymer fillers) in a liquid electrolyte, gel-forming agents to thicken the liquid, etc. In some embodiments, polymers such as polyethylene oxide (PEO), poly(vinylidene fluoride) (PVDF), poly(vinylidene fluoride-co-hexafluoropropylene (PVDF-HFP), polyacrylonitrile (PAN), etc., or a mixture thereof may be included in addition to the lithium salts dissolved in a solvent medium. In other embodiments, ceramic fillers such as aluminum oxide (Al₂O₃), silicon dioxide (SiO₂), titanium dioxide (TiO₂), lithium aluminum oxide (LiAlO₂), lithium lanthanum zirconium oxide (LLZO), lithium aluminum titanium phosphate (LATP), lithium lanthanum titanate (LLTO), etc., or a mixture thereof can be incorporated into the electrolyte.

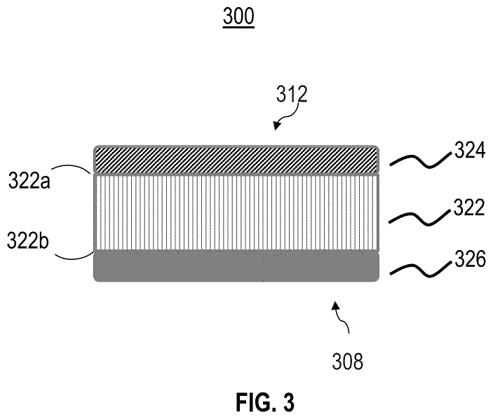

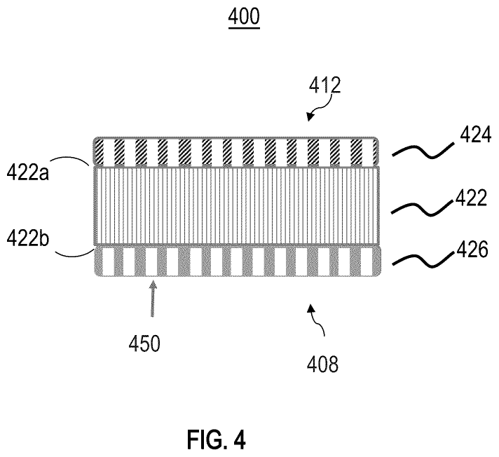

FIGS. 3 and 4 illustrate example coated separators of the present disclosure. As shown in FIG. 3, a base film (322) having a first and second major surfaces (322a, 322b) can include a coating on either or both of the surfaces. In this example, base film 322 includes a first coating (324) disposed on the first major surface (322a) and a second coating (326) disposed on the second opposing major surface (322b) of base film 322. The first coating disposed on the first major surface of the base film (e.g., a porous polymer sheet) can include a lithium ion generating compound facing the cathode (312) of a battery cell. Further, the second coating (326) disposed on the opposing second major surface (322b) of the base film (322) can include lithium metal or an alloy thereof facing the anode (308) of the battery cell.

Advantageously, the coatings can be patterned to facilitate ion transport through the separator. For example, and as illustrated in FIG. 4, a base film (422) having a first and second major surfaces (422a, 422b) can include a first coating (424) disposed on the first major surface (422a) and a second coating (426) and disposed on the second opposing major surface (422b) of base film 422. The first coating disposed on the first major surface of the base film (e.g., a porous polymer sheet) can include a lithium ion generating compound facing the cathode (412) of a battery cell. Further, the second coating disposed on the opposing second major surface of the base film can include lithium metal or an alloy thereof facing the anode (408) of the battery cell. Either or both first or second coating can be patterned. For this example, both first and second coatings are patterned to include a plurality of ion channels (450) through the coatings.

A wide variety of base films can be used for a coated separator of the present disclosure. Based films can be composed of one or more insulating materials (e.g., a polymer such as polyethylene, polypropylene, polyolefin, and/or polyamide, or other insulating materials such as rubber, glass, cellulose, etc. Commercially available separators that are suitable for some aspects of the present disclosure include, for example, polymeric porous separators produced by SEMCORP, Senior Technology, SK ie technology, Asahi Kasei (Hipore), Asahi Kasei (Celgard), W-Scope, Entek, LG Chem, Toray Tonen (Battery separator film (BSF)), Evonik industries (SEPARION), DuPont (Energain).

The base film of a separator of the present disclosure can include a porous polymer sheet having a first major surface and an opposing second major surface and a first coating disposed on the first major surface of the porous polymer sheet, which includes a lithium ion generating compound.

In some aspects, a lithium ion generating compound included in a coating on a separator of the present disclosure can comprise a lithium nitride, a lithium metal oxide, a lithium transition metal phosphate, or a mixture thereof.

Advantageously, a mixture of Li₃N and binary nitride (MNₓ) materials at the battery electrode surfaces may decompose to Li⁺ ions and other stable phase(s) that can provide beneficial properties to a battery in which they are incorporated. In some instances, the Li₃N and MNₓ may react to form a ternary Li-M-N compound as an intermediate species. Upon battery cell formation and activation, nitrogen or ammonia may be evolved due during the decomposition reactions. The remaining ions may then scavenge available HF that may be present due to electrolyte decomposition. Scavenging HF can further lead to the formation of protective coating layers at the electrode surfaces.

In lithium ion batteries, fresh anode electrode surfaces consume a portion of the Li⁺ ions that are transported from the cathode side during the first few cycles of operation to form a stable, passivating solid electrolyte interphase, or “SEI.” If the anode surface area is higher (e.g., high surface area carbon, etc.), then a larger volume of SEI will form, trapping more Li⁺ ions from the cathode side. These trapped Li⁺ ions are no longer reversible for the rechargeable battery, leading to a significant decrease for the overall cell energy density. One strategy to account for the Lit ion loss is to use an additive with a high concentration of Li⁺ ions that can supply excess amount of Li ion sources. Including Li₃N in a coating on a separator facing the cathode can balance the Li⁺ loss through N₂ gas evolution during the 1^{st} cycle formation cycle. The N₂ can be vented from the cell to prevent pressure build-up. It is believed that by adding a binary nitride (MNₓ) compound with the Li₃N, enhanced SEI layers can be formed, as well as creating protective metal fluoride coatings and other lithium metal oxides to protect the electrode active materials. It is believed that similar result, but without the generation of N₂ or other gases, may be achieved by including a lithium transition metal oxide to the coating of the separator, which, upon charging, decomposes into Li⁺ and a transition metal oxide that is stable on the surface of, and protective of, the separator.

In an aspect, a separator for a lithium ion battery has a coating facing the cathode that includes a lithium ion generating compound such as a mixture of Li₃N and a MNₓ, wherein MNₓ is a metal nitride that includes a metal (M) selected from Na, K, Ca, Mg, Ba, V, Nb, Ti, Zr, Sr, or a mixture of any two or more thereof. In other aspects, the separator coating can include a lithium metal oxide, in which the metal is Ti, Mo, Mn, Co, Fe, Bi, W, or Ni, or a mixture of any two or more thereof, and/or a lithium transition metal phosphate, in which the transition metal is V or Cr, or a mixture thereof. Where the lithium ion generating compound includes a mixture of Li₃N and MNₓ, the metal nitride contains one or more metals (M) selected from Na, K, Ca, Mg, Ba, V, Nb, Ti, Zr, and Sr. In various embodiments, the MNₓ may be any one or more metal nitrides selected from Ba₃N₂, NaN₃, KN₃, VN, NON, TiN, ZrN, Sr₃N₂, Ca₃N₂, and Mg₃N₂. It is understood that the value of x (in the MNₓ) is not provided as it is merely a designation of a metal nitride, the stoichiometry of which may vary and be fractional amounts when normalized to the amount of “M” to be recited. Accordingly, to the extent a definition is required it may be from greater than 0 to about 5, including fractional amounts, depending on the stoichiometric ratio of the nitrogen to the metal. Even higher amounts can be expressed as fractional amounts if the metal is normalized to 1.

In some aspects, the metal nitride is Ba₃N₂, NaN₃, or KN₃, or a combination of any two or more thereof. In such combinations, a molar ratio of Li₃N to MNₓ may be from greater than 0 to about 1. In other combinations, the molar ratio may be from 2 to 10, from 2 to 8, from 2 to 6, from 2 to 4, about 2, about 3, about 4, about 5, about 6, about 7, about 8, about 9, or about 10. In other combinations, the MNₓ may be VN, NbN, TiN, or ZrN, or a combination of any two or more thereof. In such embodiments, a molar ratio of Li₃N to MNₓ may be greater than about 2. For example, the molar ratio in such embodiment may be greater than about 3, from 2 to 10, from 2 to 8, from 2 to 6, from 2 to 4, about 2, about 3, about 4, about 5, about 6, about 7, about 8, about 9, or about 10. In still other embodiments, MNₓ may be Sr₃N₂, Ca₃N₂, or Mg₃N₂, or a combination of any two or more thereof. In such embodiments, a molar ratio of Li₃N to MNₓ may be greater than about 0.5. For example, the molar ratio in such embodiment may be greater than about 0.75, greater than about 1, from 0.5 to 10, from 0.5 to 8, from 0.5 to 6, from 0.5 to 4, about 0.5, about 0.75, about 1, about 2, about 3, about 4, or about 5.

In other aspects, a coated separator facing a cathode can include a lithium ion generating compound such as a lithium metal oxide, a lithium transition metal phosphate, or a mixture thereof. In such compounds, the metal of the lithium metal oxide may be Ti, Mo, Mn, Co, Fe, Bi, W, Ni, or a mixture of any two or more thereof. Further, the transition metal of the lithium transition metal phosphate may be V or Cr, or a mixture thereof. Examples of lithium ion generating compounds as a lithium metal oxide may be one or more of LiTiO₂, LiMoO₂, Li₇Ti₁₁O₂₄, Li₆MnO₄, Li₆CoO₄, Li₅Ti₃O₈, Li₂CoO₂, Li₆FeO₄, LigBiO₆, LiW₂O₆, and LigNiO₄. In some embodiments, the lithium generating species may be one or more of LiTiO₂, LiMoO₂, LiVPO₄, and LiCrPO₄. Examples of a lithium ion generating compound as a lithium transition metal phosphate includes one or both of LiVPO₄ and LiCrPO₄.

In addition to a coating including a lithium ion generating compound, coated separators of the present disclosure can also include a coating facing the anode that, e.g., a second coating disposed on the opposing second major surface of the porous polymer sheet, of lithium metal or alloy thereof. For example, such a coating can include a lithium alloy of LiₓM¹, in which M¹ is Si, Sn, Ge, Al, or any combination thereof. Further such a coating of lithium metal or lithium metal alloy can further be mixed with and include Li₂CO₃, Li₂O, LiF, a titanium oxide (e.g., Ti_{y}O_{z}), polypyrrole (PPy), graphene, or any combination thereof.

Advantageously, either or both of the coatings on either the first or second major surface of a separator can further include a ceramic such as Al₂O₃, SiO₂, and/or metal oxyhydroxide such as AlO(OH); and (ii) ScO(OH), VO(OH), FeO(OH), GaO(OH), MnO(OH), and/or InO(OH).

The coatings can be formed on the surface of a base film of a separator by preparing a slurry from a powdered form of the lithium ion generating compound or lithium metal or lithium alloy as the case may be and combining the powder with a binder in a solvent medium such as in N-methylpyrrolidone (NMP), or other suitable solvent, to form a slurry. The slurry can then be coated on the surface of the separator and dried with or without heat and/or pressure to form a first coating on a first major surface of the base film and optionally a second coating on the second major surface of the base film if desired. The coating process can be conducted by but not limited to roll-coating, blade-coating, spin-coating, spray-coating, dip-coating, physical vapor deposition (PVD), chemical vapor deposition (CVD), transferring from an existing coating on a foreign surface or a mixture of thereof. Patterned coatings can be formed by applying the slurry to a patterned mask on the base film.

Tables 1 and 2 below provide further examples of lithium ion generating compounds and lithium metal and alloys thereof, respectively, that can be used to coat a porous separator.

TABLE 1
Lithium ion generating compounds and mixtures that can be used
to coat the cathode facing surface of a porous separator.

| | |
|---|---|
| Li₂NiO₂ | LiW₂O₆ |
| Li₅FeO₄ | Li₆NiO₄ |
| Li₂CuO₂ | LiVPO₄ |
| LiFeO₂/Li₂MoO₃ | LiCrPO₄ |
| Li₆CoO₄ | Li₁₊ₓMn₂O₄ |
| M/Li₂O (M = Cu, Pb, Cu, Co, Ni, Mn, Ru, Mo) | LiₓMn₂O₄ |
| Li₃N/MNₓ (M = Na, K, Ca, Mg, Ba, V, Nb, Ti, Zr, | Li₁₊ₓNi_{0.5}Mn_{1.5}O₄ |
| Sr or mixture of them) | |
| LiTiO₂ | Li₁₊ₓNiₐMn_{b}Co_{c}O₂ |
| LiMoO₂ | Li₃V₂(PO₄)₃ |
| Li₇Ti₁₁O₂₄ | Li₅V₂(PO₄)₃ |
| Li₆MnO₄ | Li₂Co_{0.4}Mn_{1.6}O₄ |
| Li₅Ti₃O₈ | Li₂O₂/NCM |
| Li₂CoO₂ | Li₂C₂O₄ |
| Li₆FeO₄ | Li₃P/graphene |
| Li₈BiO₆ | |

TABLE 2
Example lithium metal and alloys thereof that can be used
to coat the anode facing surface of a porous separator.

Li Metal
Li/Li₂CO₃
LiₓM (M = Si, Sn, Ge, Al)
LiₓSi/Li₂O
LiₓSi/LiF
LiₓSi—Li₂O/Ti_{y}O_{z}
LiₓSn/PPy
LiₓSn/Graphene

In an aspect, a coated separator can include Li₂NiO₂ and Li₅FeO₄ in a coating on a first coating disposed on the first major surface of the porous polymer sheet as a lithium ion generating compound and optionally lithium metal disposed on the opposing second major surface of the porous polymer sheet.

The battery cell of the present disclosure further can include a cathode and an anode. A wide variety of cathode materials can be used in a battery cell including a coated separator of the present disclosure. Such cathode active materials can be composed of, without limitation: one or more lithium metal oxides, e.g., a lithium cobalt oxide, a lithium manganese oxide, a lithium nickel manganese cobalt oxide (NMC), lithium nickel cobalt aluminum oxide (NCA), over-lithiated oxides (OLO), which includes an excess stoichiometric mole amount of lithium in a lithium metal oxide, etc., and/or a particular OLO, referred to as a lithium-manganese-rich (LMR) compound, which includes an excess stoichiometric mole amount of lithium and a high amount of manganese, and/or a high-entropy lithium oxide cathode, and/or a lithium metal phosphate, such as a lithium iron phosphate, lithium manganese phosphate, lithium manganese iron phosphate, etc., lithium spinel, or any combinations thereof. In some aspects, the OLO active material has a formula of: Li_{1+y}M_{1-y}O₂, where 0<y≤0.4 and Mis a transition metal such as Ni and/or Mn, which may be doped with Al. In other aspects, an LMR compound can have a formula of: Li_{1+y} (M_{1-y}) O₂, which includes a high portion of manganese and lithium, where 0<y≤0.25 and M is a transition metal including Mn, which can also include Ni, and can be doped with cobalt. In still further aspects, either the OLO active material and/or the LMR compound has less than about 7 wt % cobalt, such as less than 3 wt %, or less than 2 wt % cobalt.

In addition, a wide variety of anode materials can be used with a battery cell having a coated separator of the present disclosure, which include, without limitation: lithium metal, a lithium metal alloy, a graphitic carbon (e.g., ordered or disordered carbon with sp² hybridization, artificial or natural graphite, or blends thereof), a non-graphitic carbon (e.g. hard carbon, soft carbon, char, glassy carbon, and the like, or blends thereof), a metal oxide (e.g., lithium titanate), silicon, a silicon-based material (e.g., silicon-based carbon composite, silicon oxide, carbide, a pre-lithiated silicon material), etc. a hybrid active material (e.g., having a combination of a lithiophilic material and intercalation material), alloying anodes (e.g. tin based, tin oxide, etc.) or a combination of any two or more thereof.

In accordance with aspects of the subject technology, a method is provided that includes: obtaining a battery having a cell (e.g., a battery cell 120), the cell including a cathode (e.g., cathode 212), an anode (e.g., anode 208), a separator (e.g., separator 300 or 400) of the present disclosure and a liquid electrolyte, and operating the cell by charging the cell of the battery, and/or discharging the cell of the battery. Discharging the battery cell can provide electrical power to a power-consuming component (e.g., a vehicle and/or an electrical system of a building).

Aspects of the subject technology can help improve the serviceability of electrical power supplies, such as batteries and/or battery packs. This can help facilitate the functioning of and/or proliferation of electric vehicles, which can positively impact the climate by reducing greenhouse gas emissions.

A reference to an element in the singular is not intended to mean one and only one unless specifically so stated, but rather one or more. For example, “a” module may refer to one or more modules. An element preceded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A coated separator for a rechargeable battery, comprising:
a porous polymer sheet having a first major surface and an opposing second major surface; and
a first coating disposed on the first major surface of the porous polymer sheet comprising a lithium ion generating compound.

2. The coated separator of claim 1, further comprising a second coating disposed on the opposing second major surface of the porous polymer sheet comprising lithium metal or an alloy thereof.

3. The coated separator of claim 1, wherein the lithium ion generating compound comprises a mixture of Li₃N and MNₓ, wherein MNₓ is a metal nitride including a metal (M) selected from Na, K, Ca, Mg, Ba, V, Nb, Ti, Zr, Sr, or a mixture of any two or more thereof.

4. The coated separator of claim 3, wherein the MNₓ comprises Ba₃N₂, NaN₃, KN₃, VN, NbN, TiN, ZrN, Sr₃N₂, Ca₃N₂, or Mg₃N₂, or a mixture of any two or more thereof.

5. The coated separator of claim 1, wherein the lithium ion generating compound comprises a lithium metal oxide, a lithium transition metal phosphate, or a mixture thereof, wherein the metal of the lithium metal oxide comprises Ti, Mo, Mn, Co, Fe, Bi, W, Ni, or a mixture of any two or more thereof; and the transition metal of the lithium transition metal phosphate comprises V or Cr, or a mixture thereof.

6. The coated separator of claim 1, wherein the lithium ion generating compound comprises, Li₂NiO₂, Li₅FeO₄, Li₂CuO₂, LiFeO₂/Li₂MoO₃, Li₆CoO₄, LiTiO₂, LiMoO₂, Li₇Ti₁₁O₂₄, Li₆MnO₄, Li₅Ti₃O₈, Li₂CoO₂, Li₆FeO₄, Li₈BiO₆, LiW₂O₆, LigNiO₄, or a mixture of any two or more thereof.

7. The coated separator of claim 1, wherein the lithium ion generating compound comprises LiVPO₄, LiCrPO₄, or a mixture thereof.

8. The coated separator of claim 2, wherein the second coating disposed on the opposing second major surface of the porous polymer sheet comprises lithium metal.

9. The coated separator of claim 2, wherein the second coating disposed on the opposing second major surface of the porous polymer sheet comprises a lithium alloy of LiₓM¹, wherein M¹ is Si, Sn, Ge, Al, or any combination thereof.

10. The coated separator of claim 9, wherein the second coating disposed on the opposing second major surface of the porous polymer sheet comprises a mixture of a lithium alloy with Li₂CO₃, Li₂O, LiF, Ti_{y}O_{z}, polypyrrole (PPy), graphene, or any combination thereof.

11. The coated separator of claim 2, wherein either the first or second coating is patterned.

12. A lithium ion battery cell comprising:
a cathode; an anode; and a coated separator between the cathode and anode;
wherein the coated separator comprises a porous polymer sheet having a first coating disposed on a first major surface of the porous polymer sheet comprising a lithium ion generating compound and optionally a second coating disposed on an opposing second major surface of the porous polymer sheet comprising lithium metal or an alloy thereof.

13. The lithium ion battery cell of claim 12, further comprising a liquid electrolyte including a fluoride-containing compound, or a semisolid electrolyte.

14. The lithium ion battery cell of claim 12, wherein the cathode comprises a lithium metal oxide, a lithium metal phosphate, lithium spinel, or a combination thereof.

15. The lithium ion battery cell of claim 12, wherein the anode comprises a lithium metal, a lithium metal alloy, silicon, silicon oxide, a hybrid active material, graphite, or any combination thereof.

16. The lithium ion battery cell of claim 12, wherein the lithium ion generating compound comprises a lithium metal oxide, a lithium transition metal phosphate, or a mixture thereof, wherein the metal of the lithium metal oxide comprises Ti, Mo, Mn, Co, Fe, Bi, W, Ni, or a mixture of any two or more thereof; and the transition metal of the lithium transition metal phosphate comprises V or Cr, or a mixture thereof.

17. The lithium ion battery cell of claim 12, wherein the second coating disposed on the opposing second major surface of the porous polymer sheet comprises a lithium alloy of LiₓM¹, wherein M¹ is Si, Sn, Ge, Al, or any combination thereof.

18. A vehicle comprising the lithium ion battery cell of claim 12.

19. A method, comprising:
charging and discharging a lithium ion battery cell;
wherein the lithium ion battery cell comprises: a cathode, an anode, and a coated separator between the cathode and anode; and
wherein the coated separator comprises a porous polymer sheet having a first coating disposed on a first major surface of the porous polymer sheet comprising a lithium ion generating compound facing the cathode and a second coating disposed on an opposing second major surface of the porous polymer sheet comprising lithium metal or an alloy thereof facing the anode.

20. The method of claim 19, wherein the lithium ion battery cell is charged and discharged over more than two cycles.
